(19) United States
(12) Patent Application Publication
(10) Pub. No.: US 2021/0272191 A1
(43) Pub. Date: Sep. 2, 2021

(54) AUTOMATED ACTIVATION OF LINE OF CREDIT

(71) Applicant: Wells Fargo Bank, N.A., San Francisco, CA (US)

(72) Inventors: Laura M. Fontana, San Francisco, CA (US); Amita Kheterpal, Oakland, CA (US); Daniel Oshima, San Francisco, CA (US); Samuel Ostler, Ross, CA (US); Marria Rhodriquez, San Francisco, CA (US)

(21) Appl. No.: 15/625,022

(22) Filed: Jun. 16, 2017

(51) Int. Cl. G06Q 40/02; G06Q 50/00; G06Q 10/10

(52) U.S. Cl. CPC G06Q 40/025; G06Q 10/109; G06Q 50/01

(57) ABSTRACT

Systems and methods for facilitation of peer to peer transfers of financial instrumentations associated with automated activation of lines of credit according to one or more example embodiments are shown. Such systems and methods make use of analyzing information obtained from financial institution computing system as well as other third party system such as social media networks. In some embodiments, this analysis of data allows for customers, e.g., account holders, of a financial institution to be offered opportunities for loan solutions, such as short term loan solutions, in real time when a need for such a loan solution is determined. Such loan solutions may be provided in real time when the account holders are pre-vetted for the ability to pay back the loans as well as upon a determination of means to pay back the loan in the given time period based on the analysis of the data.

### BACKGROUND

The proliferation of the internet has fundamentally changed various aspects of individuals' lives, such as communication, work, education, finance, social and personal relationships, etc. For example, the internet has remarkably increased the amount of information available and decreased the transaction cost of obtaining such information. It has also enabled new ways to analyze information available to provide short term loan needs for real time determination of loan solution needs. Loan accounts as well as other lines of credit may be automatically activated for account holders upon analysis of information associated with one or more accounts of the account holder.

### SUMMARY

One embodiment relates to a computer-implemented method of determining a need for financing, performed by a computing system. The method comprises receiving data comprising transaction information associated with a first account operating on a financial institution computing system and analyzing transaction data of the first account, by one or more processors of the computing system. The analyzing transaction data of the first account comprises predicting an outgoing financial instrument transfer from the first account associated with a first calendar date, predicting a shortfall in funds in the first account to cover the financial instrument transfer, and determining an incoming financial instrument transfer is sufficient to cover the outgoing financial instrument transfer associated with a second calendar date subsequent to the first calendar date. The method further comprises determining a loan solution sufficient to cover a difference in the first calendar date and the second calendar date by identifying an account holder of a second account operating on the financial computing system willing to provide funds to finance at least a portion of the loan solution and transmitting a loan offer consequent to determining the loan solution sufficient to cover the difference in the first calendar date and the second calendar date, wherein the loan offer is underwritten by a financial entity associated with the financial institution computing system.

Another embodiment relates to a computing system comprising a network interface, an account database configured to store account information for customers of a financial institution, and one or more processors. The one or more processors is configured for receiving data comprising transaction information associated with a first account stored in the account database of the financial institution computing system and analyzing transaction data of the first account, by the one or more processors. Analyzing the transaction data comprises predicting an outgoing financial instrument transfer from the first account associated with a first calendar date, predicting a shortfall in funds in the first account to cover the financial instrument transfer, and determining an incoming financial instrument transfer is sufficient to cover the outgoing financial instrument transfer associated with a second calendar date subsequent to the first calendar date. The one or more processors is further configured for determining a loan solution sufficient to cover a difference in the first calendar date and the second calendar date by identifying an account holder of a second account operating on the financial computing system willing to provide funds to finance at least a portion of the loan solution and transmitting, via the network interface, a loan offer consequent to determining the loan solution sufficient to cover the difference in the first calendar date and the second calendar date, wherein the loan offer is underwritten by the financial institution associated with the financial institution computing system.

Another embodiment relates to a non-transitory computer-readable media having computer-executable instructions embodied therein that, when executed by one or more processors of a computing system, cause the one or more processors to perform operations, the operations comprising the method above.

Other embodiments of the method, computing system, or non-transitory computer-readable may include additional elements. Predicting the outgoing financial instrument instrument transfer from the first account associated with the first calendar date may comprise analyzing a financial history associated with the first account to determine a number of financial instrument transfers from the first account associated with the outgoing financial instrument transfer exceeds a predetermined threshold. Determining the incoming financial instrument transfer is sufficient to cover the outgoing financial instrument transfer associated with the second calendar date may comprise analyzing the financial history associated with the first account to determine a predicted value of the incoming financial instrument transfer by analyzing values of a number of historical financial instrument transfers into the first account associated with the incoming financial instrument transfer, wherein the number of historical financial instrument transfers exceeds a second predetermined threshold. The method steps or other operations may further comprise determining the loan solution sufficient to cover the difference in the first calendar date and the second calendar date by identifying a plurality of account holders of a plurality of accounts operating on the financial computing system willing to provide a portion of the funds to finance the loan solution. The method steps or other operations may further comprise transmitting an incentive to the account holder of the second account consequent to identifying the account holder of the second account operating on the financial computing system willing to provide funds to finance at least the portion of the loan solution and consequent to receiving a confirmation from the account holder of the second account. The method steps or other operations may further comprise receiving an acceptance of the loan solution from an account holder of the first account, receiving a financial instrument transfer of at least a portion of the funds to finance the loan solution from the second account, and transmitting the at least the portion of the funds to finance the loan solution to the second account. Identifying an account holder of a second account operating on the financial computing system willing to provide funds to finance at least a portion of the loan solution may comprise selecting the account holder of the second account from a plurality of account holders, the plurality of account holders forming a lending pool, each of the plurality of account holders having a shared parameter.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a block diagram of a system for facilitating automated suggestions for short term financing according to an example embodiment.

FIG. 2 is a flow diagram of a method of analyzing transaction information to determine a loan solution to a need for short term according to an example embodiment.

FIG. 3 is a flow diagram of a method of matching loan providers to identified loan solutions according to an example embodiment.

FIG. 4 is an interface on a display of an individual computing device, including graphics displaying alert regarding automated suggestions for offers according to an example embodiment.

### DETAILED DESCRIPTION

Referring generally to the figures, systems and methods for facilitating automated activation of lines of credit according to one or more example embodiments are shown. In addition, systems and methods for facilitation peer to peer transfers of financial instrumentations associated with automated activation of lines of credit according to one or more example embodiments are shown. Such systems and methods make use of analyzing information obtained from financial institution computing system as well as other third party system such as social media networks. In some embodiments, this analysis of data allows for customers, e.g., account holders, of a financial institution to be offered opportunities for loan solutions, such as short term loan solutions, in real time when a need for such a loan solution is determined. Such loan solutions may be provided in real time when the account holders are pre-vetted for the ability to pay back the loans as well as upon a determination of means to pay back the loan in the given time period based on the analysis of the data. Increased confidence in the ability to pay back a short term loan provides opportunities to underwrite the loans provided by a peer to peer lending system between account holders while still being able to offer incentives to account holders to provide funds for the loans. This may also allow the financial institution to guarantee pay back of at least the principal of the loans to the account holders providing funds for the loans.

In addition, embodiments described herein solve the technical problem of determining the appearance and functionality of a graphical user interface providing real time alerts of loan offers to account holders based on a determined need. In some embodiments, alerts can be displayed and loan offers accepted with a single click based on a pre-vetted and opted-in account holder. The ability to send accurate and relevant real time offers and alerts is addressed by leveraging an individual account holder's transaction data as presented in one or more accounts and analyzing it to determine the timing and amount of the loan solution need.

Further, embodiments described herein solve the and internet-centric problem of providing short term loan updates, status, and other information to an application for account holders providing funding for short term loans. In some embodiments, participation in providing funds for short term loans is associated with certain demographics, shared interests, and other associations between account holders that make account holders more willing to participate in the program. Real time updates on incentives earned can also be displayed in some embodiments.

Further, embodiments described herein solve the technical and internet-centric problem of analyzing transaction data related to a triggering event to match accounts with a loan solution need to account holders willing to provide funds for short term loans. The availability of pre-vetted and opted-in account holders allows for real time matching that would otherwise be unavailable and potentially too late to address the loan solution need.

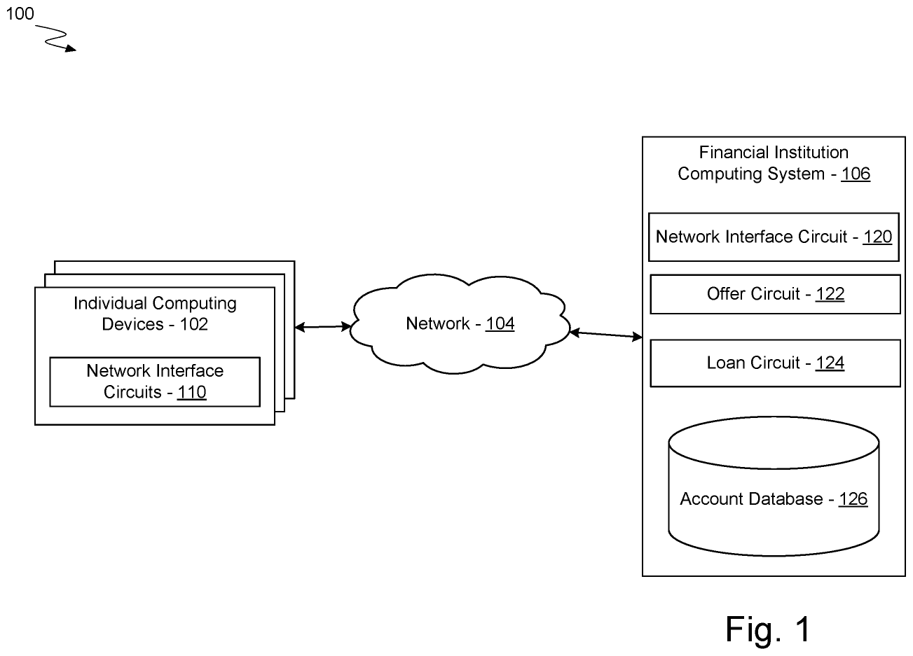

Referring now to FIG. 1, an embodiment of an environment 100 is depicted. In brief overview, the environment 100 includes one or more individual computing devices 102 used by users with financial accounts with financial institutions and connected to a network 104. Also connected to the network 104 is a financial institution computing system 108. The financial institution computing system 108 is affiliated with a financial institution, such as a bank. In some embodiments, the individual computing devices 102 communicate over the network 104 to the financial institution computing system 108. The individual computing devices 102 are smartphones, laptop computers, tablet computers, e-readers, smartwatches, and the like. In reference to components described herein, references to the components in singular or in plural form are not intended as disclaimers of alternative embodiments unless otherwise indicated. The components are configured to interact, in some embodiments, as described in further detail below.

In the environment 100, data communication between the individual computing devices 102 and the financial institution computing system 108 is facilitated by the network 104. In some embodiments, the network 104 includes the internet. In other embodiments or combinations, the network 104 includes a local area network or a wide area network. The network 104 is facilitated by short and/or long range communication technologies including Bluetooth® transceivers, Bluetooth® beacons, RFID transceivers, NFC transceivers, Wi-Fi transceivers, cellular transceivers, wired network connections (e.g., Ethernet), etc.

Still referring to FIG. 1, the individuals using individual computing devices 102 are in communication with and/or have accounts with a financial institution associated with the financial institution computing system 108. In some embodiments, individuals include single persons as well as households and families and may also include, companies, corporations, or other entities using the system(s) herein to maintain accounts with financial institutions and telecommunication companies. Individuals communicate via an individual computing device 102 over a respective network interface circuit 110 over the network 104 to a financial institution computing system 108. In some embodiments, individual computing devices 102 are mobile computing devices such as smartphones, laptop computers, tablet computers, e-readers, smartwatches, and the like. Data passing through the respective network interface circuits 110 can be encrypted such that the network interface circuit 110 is a secure communication module. The network 104 enables components of the system 100 to communicate with each other (e.g., the financial institution computing system 108). The network 104 is a data exchange medium, which may include wireless networks (e.g., cellular networks, Bluetooth®, WiFi, Zigbee®, etc.), wired networks (e.g., Ethernet, DSL, cable, fiber-based, etc.), or a combination thereof. In some embodiments, the network 104 includes the internet.

The individual computing devices 102 are mobile computing systems configured to run applications and communicate with other computer systems over a network 104. For example, the individual computing device 102 is configured to allow a customer to view financial account balances or transfer funds from a given account with a financial institution by using mobile banking circuits 116 (e.g., a circuit formed at least in part by an application associated with the financial institution and installed on the individual computing device 102). The individual computing devices 102 as depicted include network interface circuits 110. In some embodiments, the network interface circuits 110 comprise one or more Bluetooth® transceivers, RFID transceivers, NFC transceivers, Wi-Fi transceivers, cellular transceivers, and the like. In some embodiments, components of the individual computing devices 102 are connected by wired or wireless connections.

The financial institution computing system 108 is associated with a financial institution (e.g., a bank, a credit card issuer, etc.). The financial institution computing system 108 includes a network interface circuit 120, an offer circuit 122, a loan circuit 124 and an account database 126. The offer circuit 122 and the loan circuit 124 control at least some operations of the financial institution computing system 108 using data stored in databases or other computer storage structures, such as the account database 126. The offer circuit 122 is configured to determine when to make an offer to an account holder. The loan circuit 124 is configured to identify an account holder willing to provide funding for at least a portion of a loan. Data passing through the network interface circuit 120 is encrypted such that the network interface circuit 120 is a secure communication module. In some embodiments, the network interface circuit 120, offer circuit 122, loan circuit 124, and the account database 126 reside in part on different servers in relation to other components or to the whole of a particular component.

In some embodiments, the offer circuit 122 can be configured to receive transaction information associated with an account operating on the financial institution computing system 108. In some embodiments, transaction information may include any transaction information, recent or historical, of an account holder of the account involving receiving or sending financial instruments. In some embodiments, transaction information includes information associated with the account relevant to the financial health or status of the account holder, including any financial information described herein. In some embodiments, the offer circuit 122 is configured to receive the transaction information from a financial institution that provides a financial account to the user (e.g., financial institution computing system 108). In some embodiments, the offer circuit 122 is configured to receive the transaction information based on an authorization or authentication by the account holder such that one or more components of the financial institution computing system 108 is linked to one or more accounts of the account holder such that the financial institution computing system 108 is able to monitor the financial account(s) held by the account holder and pull any information required. In some embodiments, the offer circuit 122 is configured to receive financial information, including historical transaction information, from other sources as well, including credit agencies, merchants, business partners, the account holder, social media computing systems and the like.

In some embodiments, the offer circuit 122 is configured to analyze transaction information associated with an account holder to determine a need for short term financing. In some embodiments, the offer circuit 122 is configured to predict an outgoing financial instrument transfer from a first account associated with a first calendar date. The offer circuit 122 is further configured to predict a shortfall in funds in the first account to cover the financial instrument transfer. In some embodiments the offer circuit 122 is further configured to determine an incoming financial instrument transfer is sufficient to cover the outgoing financial instrument transfer associated with a second calendar date subsequent to the first calendar date. In some embodiments, the offer circuit 122 is configured to analyze the transaction information for recurring and/or predictable deposits of financial instruments (e.g., direct deposit of a paycheck, social security payment, annuity payment, etc.). In some embodiments, the offer circuit 122 is configured to use the transaction information (e.g., the analysis of the transaction information) to pre-vet an account holder to determine if they are candidates for short term loan solutions. Pre-vetting may comprise determining recurring financial transactions in an account of a user. In some embodiments, the offer circuit 122 is configured to calculate a probability regarding ability to pay back short term loans based on a predicted deposit. In some embodiments, a need is a predicted event that will result in a fee and/or penalty for an account holder or user. In some embodiments, a need is avoidance of a penalty such as a fee, a rate increase, a loss in status, a reduced credit rating, a reduced opportunity or qualification for offers, and the like. In some embodiments, the need may be a recurring need (e.g., bridge coverage is needed between an incoming deposit and outgoing withdrawal each month). The terms and conditions may be different for a recurring need where a loan solution has successfully been provided in the past and providing the loan solution is ongoing.

In some embodiments, the offer circuit 122 is configured to continually analyze the transaction information of one or more account holders. In some embodiments, the offer circuit 122 is configured to analyze the transaction information of one or more account holders at a recurring predetermined time (e.g., a day, a week, etc.) before analyzing any new transactions. In some embodiments, the offer circuit 122 is configured to wait for a predetermined time and also wait for a triggering event, such as a new transaction associated with the account, before analyzing any new transactions. In some embodiment, where the offer circuit 122 is configured to wait for a predetermined time, the offer circuit 122 is further configured to analyze all transactions during the time period of the predetermined time to determine a need.

In some embodiments, the offer circuit 122 is configured to determine a solution to address an identified need for a loan solution. In some embodiments, the offer circuit 122 is configured to determine that a loan solution is operable to address the need. In some embodiments, the loan solution is a short term loan financed by a financial institution associated with the financial institution computing system 108. In some embodiments, the loan solution is a short term loan financed by a microloan. In some embodiments, the loan solution is a peer to peer microloan. In some embodiments, the loan solution is a peer to peer microloan where the funds for the microloan are obtained from another account holder of the financial institution associated with the financial institution computing system 108.

In some embodiments, the offer circuit 122 is configured to determine whether a loan solution sufficient to cover a difference in the first calendar date and the second calendar date that has been identified. In some embodiments, the offer circuit 122 is configured to identify an account holder of a second account operating on the financial computing system 108 willing to provide funds to finance at least a portion of the loan solution. In some embodiments, determination of whether a loan solution is sufficient comprises a determination that a financial institution (e.g., the financial institution associated with the financial institution computing system 108) is willing to fund the loan solution for the amount of time identified. In some embodiments, determination of whether a loan solution is sufficient comprises a determination that a financial institution (e.g., the financial institution associated with the financial institution computing system 108) is willing to underwrite and/or guarantee a peer to peer loan from one account holder to another.

In some embodiments, the offer circuit 122 is configured to send a message or indication to an account holder of an account where there has been a determination of a need for short term financing. The message or indication may be a warning of the need for short term financing despite the lack of availability of a loan solution that would address the need.

In some embodiments, the offer circuit 122 is configured to transmit an offer consequent to determining the loan solution sufficient to cover the difference in the first calendar date and the second calendar date. In some embodiments, the loan offer is underwritten by a financial entity associated with the financial institution computing system 108. In some embodiments, the need for the loan solution is a recurring need and the account holder and the offer has been transmitted and accepted for a plurality of future transactions. For example, the loan solution may be provided once a month, every second payday, etc., without the need for providing the offer and receiving acceptance for each loan transaction.

In some embodiments, the loan circuit 124 can be configured to identify an account holder willing to provide loans and a loan solution suitable for an account holder in need of a short term loan. In some embodiments, a loan solution suitable for an account holder is a solution that covers an amount of time (e.g., calendar days) sufficient to satisfy a funding need of the account holder. In some embodiments, the loan circuit 124 is configured to identifying an account holder willing to provide a loan sufficient to satisfy a funding need (or a portion of a funding need in conjunction with other account holders providing one or more portions of the funding need) by identifying an account holder of a second account operating on the financial computing system 108 willing to provide funds to finance at least a portion of the loan solution. In some embodiments, determination of whether a loan solution is sufficient comprises a determination that a financial institution (e.g., the financial institution associated with the financial institution computing system 108) is willing to underwrite and/or guarantee the loan solution for the amount of time identified. In some embodiments, determination of whether a loan solution is sufficient comprises a determination that a financial institution (e.g., the financial institution associated with the financial institution computing system 108) is willing to underwrite and/or guarantee a peer to peer loan from one account holder to another.

In some embodiments, the loan circuit 124 is configured to evaluate financial transaction history of an account holder to determine if they are a good candidate for providing at least a portion of the funds for financing loan solutions. The analysis of financial transaction history may indicate one or more parameters of financial health of the account holder evaluated to provide loan funding. In some embodiments, other data are analyzed such as social media associated with account holder. The analysis of data from social media may provide a further indicator of the financial health of the account holder, major life events, and the like.

In some embodiments, the loan circuit 124 is configured to calculate a stability rating for an account holder in need of a loan solution. The stability rating may be based on a duration of time where one or more similar incoming financial instruments deposits and withdrawals are detected in one or more accounts of the account holder. The stability rating may be weighted using one or more parameters such as type of transaction, identity sender or receiver of the deposits and withdrawals, third party data supporting the continuation of the deposits and/or withdrawals, and the like.

In some embodiments, the loan circuit 124 is configured to match a willing loan provider to a loan solution. In some embodiments, the loan circuit 124 is configured to match a plurality of loan providers to a loan solution, each providing a portion of the needed loan amount. In some embodiments, the loan circuit 124 is configured to match one or more parameters in order to match a loan provider to a loan solution. The one or more parameters may be one or more of a minimum required credit score, a minimum return on investment, a minimum loan duration, a maximum loan duration, a shared demographic, a shared user interest, a minimum social media presence, and the like. The loan circuit 124 may be configured to determine similar users based on demographic information associated with the user, including age, gender, income level, and the like. In some embodiments, the loan circuit 124 further determines a match of the loan providers to loans solutions based on a similarity of the account holders. Similarity of account holders may be based on family composition and demographic information for family members, geographic location, and occurrence of significant life events (e.g., marriage, childbirth, divorce, job change, etc.). In some embodiments, similar account holders are based on a social networking profile of the account holder, including based on listed interests in social profiles, social profile activity, number of social connections, number of followers, etc. The group of account holders evaluated for matches may also be selected from a group associated with the account holder in need of a loan (e.g., from a list of account holders with shared transaction history to the account holder, from the account holder's social connections, etc.). In some embodiments, the loan circuit 124 is configured to match a loan provider to a loan producer by analyzing the group. In some embodiments, the loan circuit 124 is configured to form a lending pool from a group of account holders based on one or more parameters. The parameters may be based on demographic, location, shared interests, social networking connections, etc. In some embodiments, an account holder needs to be willing to provide short term loan funding to the lending pool in order to be eligible to receive short term funding when needed. In some embodiments, a predetermined threshold of participation is needed to be eligible to receive short term funding. The threshold of participation may be based on number of transactions where an account holder has provided at least a portion of funds needed for a short term peer to peer loan. The threshold of participation may also be based on other metrics such as participation in social media in connection with the lending pool, amount of data provided to a financial solution to help analyze a financial situation of the account holder, participation in off-line events associated with the lending group, and the like.

In some embodiments, the loan circuit 124 is configured to determine an incentive to the lender. In some embodiments, an incentive comprises a return on the loan (e.g., a flat rate or percentage of the loan). In some embodiments, other incentives may comprise preferential rates on loans, preferential rates on other financial instruments (e.g., certificates of deposit), rewards programs, faster access to funds from loans, and the like. In some embodiments, any return on a loan may be applied to an identified goal (e.g., placed in a separate savings account to fund vacations). In some embodiments, any return on a loan may be automatically placed in a savings plan (e.g., a savings account for retirement).

In some embodiments the loan circuit 124 is configured to receive a confirmation of acceptance of the loan solution by an account holder. In some embodiments, an account holder has opted-in to receiving the short term financing offers and the confirmation is just an approval to receive the particular funding. In some embodiments, confirmation is also required for one or more account holders providing the funds for the short term loan.

In some embodiments, the loan circuit 124 is configured to underwrite the loan provided by a loan solution. In some embodiments, the loan circuit 124 is configured to approved and send the loan solution as part of an automated activation line of credit. In some embodiments, based on previously obtained permissions and financial information, the loan is already automatically underwritten. In some embodiments, the account holder has to opt in to have access to the automated activation of the line of credit when needed. In some embodiments, the loan circuit 124 is configured to transfer the loan funds as soon as the confirmation is received. The confirmation may comprise an acceptance of the terms and conditions of the offer. In some embodiments, the loan circuit 124 is configured to create a separate account when a loan for an offered loan solution is sent to an account holder, the separate account in an inactive status until a confirmation is received. The loan circuit 124 is configured to activate the separate account upon receipt of the confirmation and send the funds for the loans solution. The creation of the inactive, separate account may require a previous opt-in of an account holder to create such accounts to speed up receipt of funds for offered loan solutions. In some embodiments, prequalification of a loan, automatically creates a separate account in an inactive status that will be activated upon receipt of confirmation and/or approval by the account holder.

In some embodiments, the loan circuit 124 is configured to transfer the funds for the loan upon receiving confirmation. In some embodiments, the loan circuit 124 is configured to transfer the funds for the loan immediately upon receiving a confirmation. In some embodiments, there may be another triggering event before the funds for the loan are transferred. Other triggering events may be a date associated with when the funds are needed, a further confirmation requirement from a financial institution, a further confirmation requirement from one or more account holders providing the funds for the loan, a confirmation of an underwriting of the loan by a financial institution, and the like.

In some embodiments, the accounts database 126 is configured to allow the financial institution computing system 108 to retrievably store customer information relating to the various operations discussed herein, and may include non-transient data storage mediums (e.g., local disc or flash-based hard drives, local network servers, and the like) or remote data storage facilities (e.g., cloud servers). The accounts database 126 includes personal customer information (e.g., names, addresses, phone numbers, etc.), identification information (e.g., PINs, social security numbers, driver's license numbers, biometric data, associated device IDs, associated SIM card IDs etc.), and customer financial information (e.g., account numbers, account balances, available credit, credit history, transaction histories, etc.).

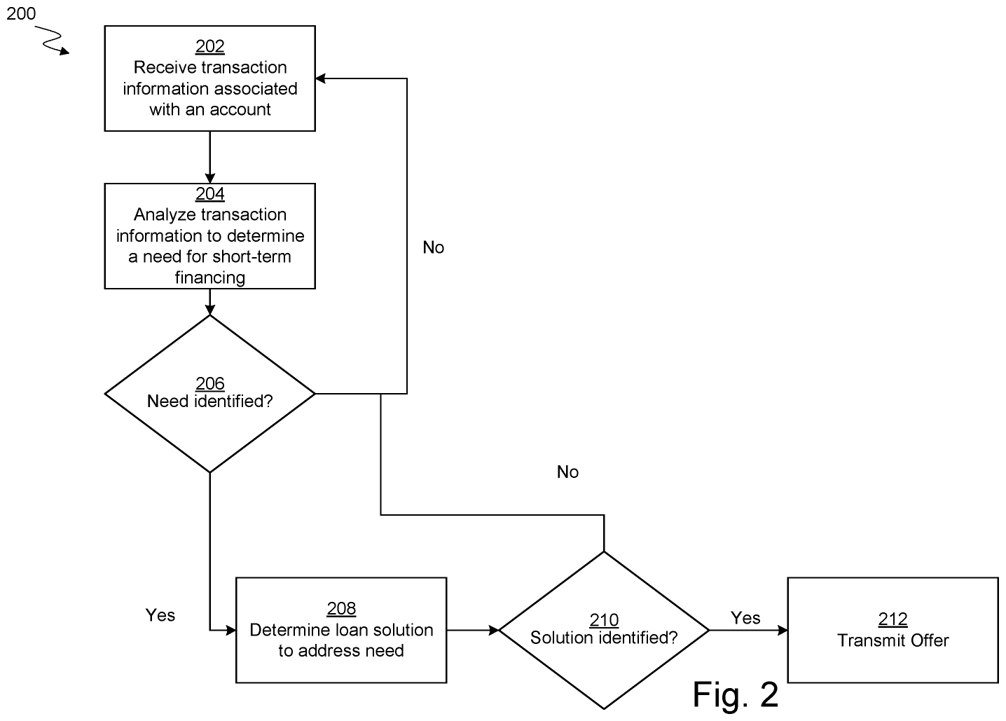

Referring now to FIG. 2, a flow diagram of a method 200 of analyzing transaction information to determine a loan solution to a need for short term is shown. In some embodiments, the method 200 is performed by a financial institution computing system associated with a financial institution (e.g., a financial institution computing system 108). In some embodiments, the method 300 is performed by an offer circuit 122 of a financial institution computing system 108. While performing the method 200, the financial institution computing system 108, for example, communicates data over a network interface circuit 120 over the network 104 to individual computing devices 102. Method 200 comprises receiving transaction information associated with an account, analyzing transaction information to determine a need for short-term financing, determining a loan solution to address that need, and transmitting an offer.

The method 200 begins when transaction information associated with an account operating on the financial institution computing system 108 is received at 202. In some embodiments, transaction information may include any transaction information, recent or historical, of an account holder of the account involving receiving or sending financial instruments. In some embodiments, transaction information includes information associated with the account relevant to the financial health or status of the account holder, including any financial information described herein. In some embodiments, the transaction information is received from a financial institution that provides a financial account to the user (e.g., financial institution computing system 108). In some embodiments, the transaction information is received by the offer circuit 122 from an account database 126 of a financial institution computing system 108. In some embodiments, the transaction information is received based on an authorization or authentication by the account holder such that one or more components of the financial institution computing system 108 is linked to one or more accounts of the account holder such that the financial institution computing system 108 is able to monitor the financial account(s) held by the account holder and pull any information required to use in the method. In some embodiments, financial information, including historical transaction information, is also received from other sources, including credit agencies, merchants, business partners, the account holder, social media computing systems and the like.

The transaction information is analyzed by the financial institution computing system 108 to determine a need for short term financing at 204. In some embodiments, the financial institution computing system 108 predicts an outgoing financial instrument transfer from a first account associated with a first calendar date. The financial institution computing system 108 then predicts a shortfall in funds in the first account to cover the financial instrument transfer. The financial institution computing system 108 then determines an incoming financial instrument transfer is sufficient to cover the outgoing financial instrument transfer associated with a second calendar date subsequent to the first calendar date. In some embodiments, transaction information is analyzed for recurring and/or predictable deposits of financial instruments (e.g., direct deposit of a paycheck, social security payment, annuity payment, etc.). In some embodiments, the transaction information is used to pre-vet an account holder to determine if they are candidates for short term loan solutions. Pre-vetting may comprise determining recurring financial transactions in an account of a user. In some embodiments, a probability is calculated regarding ability to pay back short term loans based on a predicted deposit.

At 206, it is determined whether a need for short-term financing has been identified by the financial institution computing system 108. In some embodiments, a need is a predicted event that will result in a fee and/or penalty for an account holder or user. In some embodiments, a need is avoidance of a penalty such as a fee, a rate increase, a loss in status, a reduced credit rating, a reduced opportunity or qualification for offers, and the like. In some embodiments, the need may be a recurring need (e.g., bridge coverage is needed between an incoming deposit and outgoing withdrawal each month). The terms and conditions may be different for a recurring need where a loan solution has successfully been provided in the past and providing the loan solution is ongoing.

If no need for short-term financing was identified by the financial institution computing system 108 at 206, then the process restarts at 202. In some embodiments, transaction information is continually analyzed. In some embodiments, the method may wait for a predetermined time (e.g., a day, a week, etc.) before analyzing any new transactions in the method. In some embodiments, the method may wait for a predetermined time and also wait for a triggering event, such as a new transaction associated with the account, before analyzing any new transactions in the method. In some embodiment where the method waits for a predetermined time, when the method restarts at 202, all transactions during the time period of the predetermined time are analyzed to determine a need.

If a need for short-term financing was identified by the financial institution computing system 108 at 206, then a solution to address the need is determined at 208. In some embodiments, there is a determination that a loan solution is operable to address the need determined at 206. In some embodiments, the loan solution is a short term loan financed by a financial institution associated with the financial institution computing system 108. In some embodiments, the loan solution is a short term loan financed by a microloan. In some embodiments, the loan solution is a peer to peer microloan. In some embodiments, the loan solution is a peer to peer microloan where the funds for the microloan are obtained from another account holder of the financial institution associated with the financial institution computing system 108.

At 210, it is determined whether a loan solution sufficient to cover a difference in the first calendar date and the second calendar date has been identified. In some embodiments, the determination comprises identifying an account holder of a second account operating on the financial computing system 108 willing to provide funds to finance at least a portion of the loan solution. In some embodiments, determination of whether a loan solution is sufficient comprises a determination that a financial institution (e.g., the financial institution associated with the financial institution computing system 108) is willing to fund the loan solution for the amount of time identified. In some embodiments, determination of whether a loan solution is sufficient comprises a determination that a financial institution (e.g., the financial institution associated with the financial institution computing system 108) is willing to underwrite and/or guarantee a peer to peer loan from one account holder to another.

If no loan solution was identified at 210, then the process restarts at 202. In some embodiments, a message or indication is sent to an account holder of an account where there has been a determination of a need for short term financing. The message or indication may be a warning of the need for short term financing despite the lack of availability of a loan solution that would address the need. In some embodiments, other options for short term financing may be included in the message or indication (e.g. third party solutions).

If a loan solution was identified at 210, then an offer consequent to determining the loan solution sufficient to cover the difference in the first calendar date and the second calendar date is transmitted by the financial institution computing system 108 at 212. In some embodiments, the loan offer is underwritten by a financial entity associated with the financial institution computing system 108. In some embodiments, the need for the loan solution is a recurring need and the account holder and the offer has been transmitted and accepted for a plurality of future transactions. For example, the loan solution may be provided once a month, every second payday, etc., without the need for providing the offer and receiving acceptance for each loan transaction.

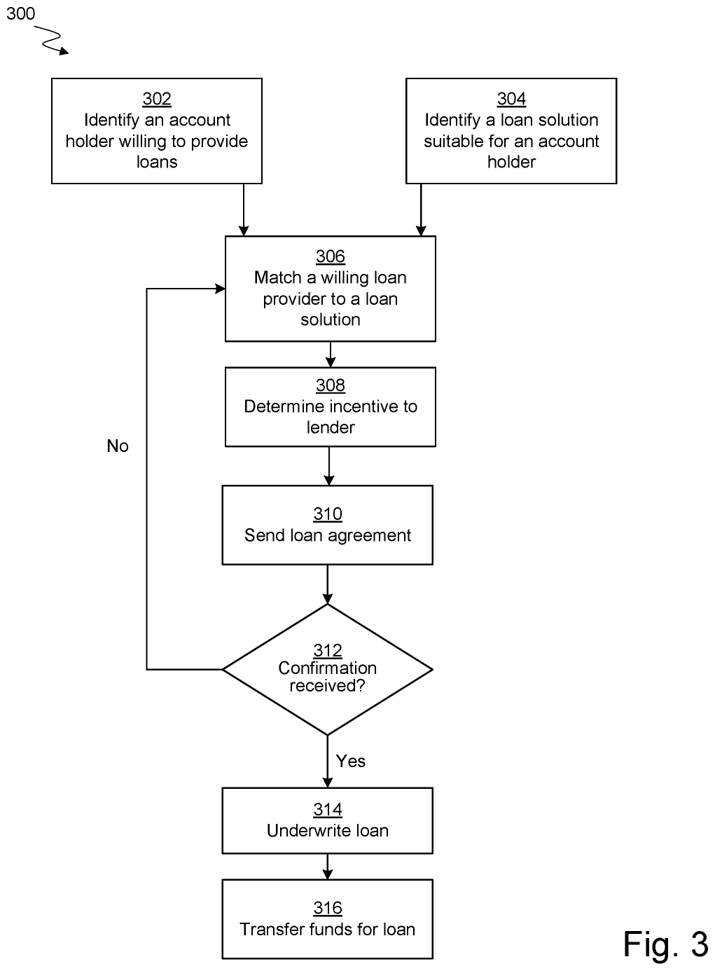

Referring now to FIG. 3, a flow diagram of a method 300 of matching loan providers to identified loan solutions is shown. In some embodiments, the method 300 is performed by a financial institution computing system associated with a financial institution (e.g., a financial institution computing system 108). In some embodiments, the method 300 is performed by a loan circuit 124 of a financial institution computing system 108. While performing the method 300, the financial institution computing system 108, for example, communicates data over a network interface circuit 120 over the network 104 to individual computing devices 102. Method 300 comprises identifying an account holder willing to provide loans and identifying a loan solution suitable for that account holder, matching a willing loan provider to a loan solution, determining an incentive to the lender, sending a loan agreement, underwriting the loan, and transferring funds for the loan.

The method 300 begins when an account holder willing to provide loans is identified at 302 and when a loan solution suitable for an account holder is identified at 304. In some embodiments, a loan solution suitable for an account holder is a solution that covers an amount of time (e.g., calendar days) sufficient to satisfy a funding need of the account holder. In some embodiments, the identifying an account holder willing to provide a loan sufficient to satisfy a funding need (or a portion of a funding need in conjunction with other account holders providing one or more portions of the funding need) comprises identifying an account holder of a second account operating on the financial computing system 108 willing to provide funds to finance at least a portion of the loan solution. In some embodiments, determination of whether a loan solution is sufficient comprises a determination that a financial institution (e.g., the financial institution associated with the financial institution computing system 108) is willing to underwrite and/or guarantee the loan solution for the amount of time identified. In some embodiments, determination of whether a loan solution is sufficient comprises a determination that a financial institution (e.g., the financial institution associated with the financial institution computing system 108) is willing to underwrite and/or guarantee a peer to peer loan from one account holder to another.

In some embodiments, financial transaction history of an account holder is evaluated to determine if they are a good candidate for providing at least a portion of the funds for financing loan solutions. The analysis of financial transaction history may indicate one or more parameters of financial health of the account holder evaluated to provide loan funding. In some embodiments, other data are analyzed such as social media associated with account holder. The analysis of data from social media may provide a further indicator of the financial health of the account holder, major life events, and the like.

In some embodiments, a stability rating is calculated for an account holder in need of a loan solution. The stability rating may be based on a duration of time where one or more similar incoming financial instruments deposits and withdrawals are detected in one or more accounts of the account holder. The stability rating may be weighted using one or more parameters such as type of transaction, identity sender or receiver of the deposits and withdrawals, third party data supporting the continuation of the deposits and/or withdrawals, and the like.

A willing loan provider is matched to a loan solution at 306. In some embodiments, a plurality of loan providers are matched to a loan solution, each providing a portion of the needed loan amount. In some embodiments, one or more parameters are matched in order to match a loan provider to a loan solution. The one or more parameters may be one or more of a minimum required credit score, a minimum return on investment, a minimum loan duration, a maximum loan duration, a shared demographic, a shared user interest, a minimum social media presence, and the like. may determine similar users based on demographic information associated with the user, including age, gender, income level, and the like. In some embodiments, the loan providers to loans solutions may be further determined based on a similarity of the account holds. Similarity of account holders may be based on family composition and demographic information for family members, geographic location, and occurrence of significant life events (e.g., marriage, childbirth, divorce, job change, etc.). In some embodiments, similar account holders are based on a social networking profile of the account holder, including based on listed interests in social profiles, social profile activity, number of social connections, number of followers, etc. The group of account holders evaluated for matches may also be selected from a group associated with the account holder in need of a loan (e.g., from a list of account holders with shared transaction history to the account holder, from the account holder's social connections, etc.) Once the group of account holders is determined, the matching of a loan provider to a loan producer is determined by analyzing the group. In some embodiments, a group of account holders is formed in to a lending pool based on one or more parameters. The parameters may be based on demographic location, shared interests, social networking connections, etc. In some embodiments, an account holder needs to be willing to provide short term loan funding to the lending pool in order to be eligible to receive short term funding when needed. In some embodiments, a predetermined threshold of participation is needed to be eligible to receive short term funding. The threshold of participation may be based on number of transactions where an account holder has provided at least a portion of funds needed for a short term peer to peer loan. The threshold of participation may also be based on other metrics such as participation in social media in connection with the lending pool, amount of data provided to a financial solution to help analyze a financial situation of the account holder, participation in off-line events associated with the lending group, and the like.

A determination of an incentive to the lender is made at 308. In some embodiments, an incentive comprises a return on the loan (e.g., a flat rate or percentage of the loan). In some embodiments, other incentives may comprise preferential rates on loans, preferential rates on other financial instruments (e.g., certificates of deposit), rewards programs, faster access to funds from loans, and the like. In some embodiments, any return on a loan may be applied to an identified goal (e.g., placed in a separate savings account to fund vacations). In some embodiments, any return on a loan may be automatically placed in a savings plan (e.g., a savings account for retirement).

At 310, it is determined whether a confirmation has been received. In some embodiments, an account holder has opted-in to receiving the short term financing offers and the confirmation is just an approval to receive the particular funding. In some embodiments, confirmation is also required for one or more account holders providing the funds for the short term loan. If a confirmation was not received at 312, then the process restarts at 306.

If a confirmation was received at 312, then the loan is underwritten at 314. In some embodiments, the loan is approved and sent as part of an automated activation line of credit. In some embodiments, based on previously obtained permissions and financial information, the loan is already automatically underwritten. In some embodiments, the account holder has to opt in to have access to the automated activation of the line of credit when needed. In some embodiments, the loan funds can be transferred as soon as the confirmation was received. The confirmation may comprise an acceptance of the terms and conditions of the offer. In some embodiments, a separate account is created when a loan for an offered loan solution is sent to an account holder, the separate account in an inactive status until a confirmation is received. Upon receipt of the confirmation, the separate account is activated and the funds for the loans solution are sent. The creation of the inactive, separate account may require a previous opt-in of an account holder to create such accounts to speed up receipt of funds for offered loan solutions. In some embodiments, prequalification of a loan, automatically creates a separate account in an inactive status that will be activated upon receipt of confirmation and/or approval by the account holder.

The funds for the loan are transferred at 316. In some embodiments, the funds for the loan are transferred immediately upon receiving a confirmation. In some embodiments, there may be another triggering event before the funds for the loan are transferred. Other triggering events may be a date associated with when the funds are needed, a further confirmation requirement from a financial institution, a further confirmation requirement from one or more account holders providing the funds for the loan, a confirmation of an underwriting of the loan by a financial institution, and the like.

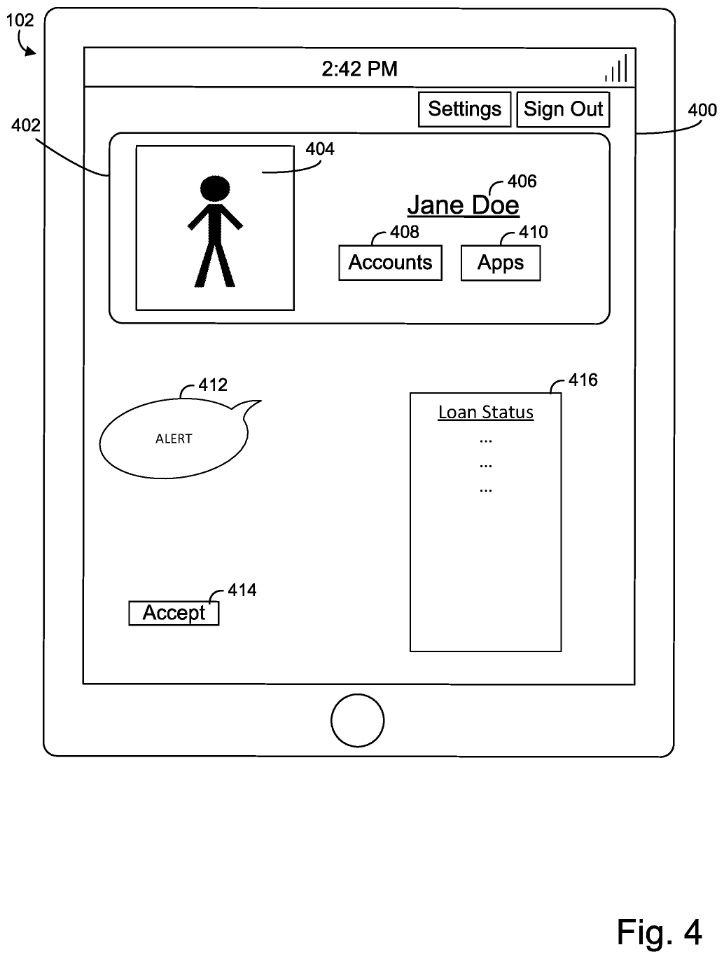

Referring now to FIG. 4, an interface 400 on a display of an individual computing device 102 including graphics displaying alerts 412 regarding automated suggestions for offers according to an example embodiment. The interface 400 on a display of an individual computing device 102 includes an account holders information 204, including an avatar 404, a username 406, an accounts button 408, and an apps button 410. In some embodiments, the accounts button 408 provides access to one or more accounts of the user of the individual computing device 102 to accounts held with a financial institution. In some embodiments, the Apps button 410 provides access to one or more applications installed on the individual computing device that interface with one or more accounts of the user of the individual computing device 102 held with a financial institution.

In some embodiments, a graphic is generated based on any received offers for short term loan solutions. For example, the graphic may include a pop-up of an alert 412 indicating an offer of a loan solution. In some embodiments, an account holder and user of the individual computing device 102 can click on the alert 412 to obtain more information on the terms of the offer and why the offer is being provided. In some embodiments, more information is provided on a predicted short term need of the account holder and how the loan solution addresses the short term need. In some embodiments, the offer can be immediately accepted by using an accept button 414. The new account generated and/or activated by the acceptance may then shortly be accessible by using the accounts button 4108. The loan status of any pending or current loan solution may be displayed in a loan status information window 416.

In some embodiments, a graphic is generated based on any received offers for providing funds to fund or partially fund a short term loan solution for another account holder. For example, the graphic may include a pop-up of an alert indicating an offer to provide funds for compensation. In some embodiments, an account holder and user of the individual computing device 102 can click on the alert to obtain more information on the terms of the offer and any risks involved. In some embodiments, an account holder can opt for a greater reward or return if they decline underwriting of the loan by the financial institution providing the offer. The loan status of any pending or current loan solution may be displayed in a loan status information window 416.

In some embodiments, a graphic is generated based on any received offers for short term loan solutions. For example, the graphic may include a pop-up of an alert indicating an offer of a loan offer. In some embodiments, an account holder and user of the individual computing device 102 can click on the alert to obtain more information on the terms of the offer and why the offer is being provided. In some embodiments, more information is provided on a predicted short term of the account holder and how the direct representation of the financial health rating of the user,

Other indications may be displayed indicating one or parameters associated with the receiving and providing of loan solutions. (e.g., an icon, badge, etc.) of individual account holder achievements or goals reached for certain financial activities (e.g., lending, borrowing, eliminating the need for future recurring borrowing, etc.), and the like. The graphic may include an image, icon, badge, logo, color scheme, font, or any other visual representation of the parameter associated with the account holder of the user. The graphic is configured to be displayed on a graphical user interface provided by a computing system. In some embodiments, the graphic is assigned to a social networking account (e.g., profile) of the account holder (ie.e, the user of the device). The graphic may be displayed alongside a social networking profile of the user on an interface provided by an associated social networking service.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

1. A computer-implemented method of determining a need for financing, performed by a computing system, the method comprising:
receiving data comprising transaction information associated with a first account operating on a financial institution computing system;
analyzing transaction data of the first account, by one or more processors of the computing system, the analyzing transaction data comprising:
predicting an outgoing financial instrument transfer from the first account associated with a first calendar date by analyzing a financial history associated with the first account to determine a number of financial instrument transfers from the first account associated with the outgoing financial instrument transfer exceeds a predetermined threshold,
predicting a shortfall in funds in the first account to cover the financial instrument transfer,
determining an incoming financial instrument transfer into the first account is sufficient to cover the outgoing financial instrument transfer associated with a second calendar date subsequent to the first calendar date by analyzing the financial history associated with the first account to determine a predicted value of the incoming financial instrument transfer by analyzing values of a number of historical financial instrument transfers into the first account associated with the incoming financial instrument transfer, wherein the number of historical financial instrument transfers exceeds a second predetermined threshold,
compute a stability rating of a first account holder of the first account, wherein the stability rating is based on a duration of time where one or more similar financial instruments are predicted to be incoming into the first account, wherein the stability rating is weighted based on one or more stability parameters comprising at least one of a type of the incoming financial instrument, identity of a sender or receiver of the incoming financial instrument, or third party data supporting the continuation of the incoming financial instrument, and
determining a setting of the first account holder indicating that the first account holder is enrolled to provide short term loan funding to other account holders;
determining, based on the stability rating and the first account holder being eligible for a loan solution responsive to the setting indicating that the first account holder is enrolled to provide short term loan funding to other account holders, the loan solution sufficient to cover a difference in the first calendar date and the second calendar date, wherein determining the loan solution comprises:
identifying one or more matching parameters of second account holders of a plurality of second accounts operating on the financial computing system, wherein the one or more matching parameters comprise at least one of a minimum required credit score, a minimum return on investment, a minimum loan duration, a maximum loan duration, a shared demographic between the first account holder and the second account holders, or a shared user interest between the first account holder and the second account holders, a minimum social media presence between first account holder and the second account holders, and
matching a subset of the second account holders to the loan solution based on the one or more matching parameters;
receiving, from at least one of the subset of second account holders, a first confirmation indicating that the at least one second account holder is willing to provide funds to finance at least a portion of the loan solution;
transmitting, to a device of the first account holder, a clickable graphic comprising an alert indicating a loan offer underwritten by a financial entity associated with the financial institution computing system, wherein clicking the graphic displays information on the predicted shortfall in funds;
receiving, from the device, a second confirmation from the first account holder indicating acceptance of the loan offer; and
transferring funds from the second account of the at least one of the subset of second account holders to the first account of the first account holder responsive to receiving the second confirmation.

2. (canceled)

3. (canceled)

4. The method of claim 1, wherein the at least one second account holder comprises a plurality of second account holders of the subset of second account holders willing to provide a portion of the funds to finance the loan solution.

5. The method of claim 1, further comprising transmitting an incentive to the at least one second account holder consequent to identifying the at least one second account holder willing to provide funds to finance at least the portion of the loan solution and consequent to receiving the first confirmation.

6. (canceled)

7. The method of claim 4, wherein the plurality of second account holders of the subset form a lending pool to finance the loan solution, each of the plurality of second account holders having a shared parameter.

8. A financial institution computing system comprising:
a network interface;
an account database configured to store account information for customers of a financial institution; and
one or more processors configured for:
receiving data comprising transaction information associated with a first account stored in the account database of the financial institution computing system;
analyzing transaction data of the first account, by the one or more processors, the analyzing transaction data comprising:
predicting an outgoing financial instrument transfer from the first account associated with a first calendar date by analyzing a financial history associated with the first account to determine a number of financial instrument transfers from the first account associated with the outgoing financial instrument transfer exceeds a predetermined threshold,
predicting a shortfall in funds in the first account to cover the financial instrument transfer,
determining an incoming financial instrument transfer into the first account is sufficient to cover the outgoing financial instrument transfer associated with a second calendar date subsequent to the first calendar date by analyzing the financial history associated with the first account to determine a predicted value of the incoming financial instrument transfer by analyzing values of a number of historical financial instrument transfers into the first account associated with the incoming financial instrument transfer, wherein the number of historical financial instrument transfers exceeds a second predetermined threshold,
compute a stability rating of a first account holder of the first account, wherein the stability rating is based on a duration of time where one or more similar financial instruments are predicted to be incoming into the first account, wherein the stability rating is weighted based on one or more stability parameters comprising at least one of a type of the incoming financial instrument, identity of a sender or receiver of the incoming financial instrument, or third party data supporting the continuation of the incoming financial instrument, and
determining a setting of the first account holder indicating that the first account holder is enrolled to provide short term loan funding to other account holders;
determining, based on the stability rating and the first account holder being eligible for a loan solution responsive to the setting indicating that the first account holder is enrolled to provide short term loan funding to other account holders, the a loan solution sufficient to cover a difference in the first calendar date and the second calendar date, wherein determining the loan solution comprises:
identifying one or more matching parameters of second account holders of a plurality of second accounts operating on the financial computing system, wherein the one or more matching parameters comprise at least one of a minimum required credit score, a minimum return on investment, a minimum loan duration, a maximum loan duration, a shared demographic between the first account holder and the second account holders, or a shared user interest between the first account holder and the second account holders, a minimum social media presence between first account holder and the second account holders, and
matching a subset of the second account holders to the loan solution based on the one or more matching parameters;
receiving, from at least one of the subset of second account holders, a first confirmation indicating that the at least one second account holder is willing to provide funds to finance at least a portion of the loan solution;
an interface configured for:
transmitting, to a device of the first account holder, a clickable graphic comprising an alert indicating a loan offer underwritten by a financial entity associated with the financial institution computing system, wherein clicking the graphic displays information on the predicted shortfall in funds
receiving, from the device, a second confirmation from the first account holder indicating acceptance of the loan offer; and
causing funds to be transferred from the second account of the at least one of the subset of second account holders to the first account of the first account holder responsive to receiving the second confirmation.

9. (canceled)

10. (canceled)

11. The computing system of claim 8, wherein the at least one second account holder comprises a plurality of second account holders of the subset of second account holders willing to provide a portion of the funds to finance the loan solution.

12. The computing system of claim 8, the one or more processors further configured for transmitting, via the network interface, an incentive to the at least one second account holder consequent to identifying the at least one second account holder willing to provide funds to finance at least the portion of the loan solution and consequent to receiving the first confirmation.

13. (canceled)

14. A non-transitory computer-readable media having computer-executable instructions embodied therein that, when executed by one or more processors of a computing system, cause the one or more processors to perform operations, the operations comprising:
receiving data comprising transaction information associated with a first account stored in the account database of the financial institution computing system;
analyzing transaction data of the first account the analyzing transaction data comprising:
predicting an outgoing financial instrument transfer from the first account associated with a first calendar date by analyzing a financial history associated with the first account to determine a number of financial instrument transfers from the first account associated with the outgoing financial instrument transfer exceeds a predetermined threshold,
predicting a shortfall in funds in the first account to cover the financial instrument transfer,
determining an incoming financial instrument transfer into the first account is sufficient to cover the outgoing financial instrument transfer associated with a second calendar date subsequent to the first calendar date by analyzing the financial history associated with the first account to determine a predicted value of the incoming financial instrument transfer by analyzing values of a number of historical financial instrument transfers into the first account associated with the incoming financial instrument transfer, wherein the number of historical financial instrument transfers exceeds a second predetermined threshold,
compute a stability rating of a first account holder of the first account, wherein the stability rating is based on a duration of time where one or more similar financial instruments are predicted to be incoming into the first account, wherein the stability rating is weighted based on one or more stability parameters comprising at least one of a type of the incoming financial instrument, identity of a sender or receiver of the incoming financial instrument, or third party data supporting the continuation of the incoming financial instrument, and
determining a setting of the first account holder indicating that the first account holder is enrolled to provide short term loan funding to other account holders;
determining, based on the stability rating and the first account holder being eligible for a loan solution responsive to the setting indicating that the first account holder is enrolled to provide short term loan funding to other account holders, the loan solution sufficient to cover a difference in the first calendar date and the second calendar date, wherein determining the loan solution comprises:
identifying one or more matching parameters of second account holders of a plurality of second accounts operating on the financial computing system, wherein the one or more matching parameters comprise at least one of a minimum required credit score, a minimum return on investment, a minimum loan duration, a maximum loan duration, a shared demographic between the first account holder and the second account holders, or a shared user interest between the first account holder and the second account holders, a minimum social media presence between first account holder and the second account holders, and
matching a subset of the second account holders to the loan solution based on the one or more matching parameters;
receiving, from at least one of the subset of second account holders, a first confirmation indicating that the at least one second account holder is willing to provide funds to finance at least a portion of the loan solution;
transmitting, to a device of the first account holder, a clickable graphic comprising an alert indicating a loan offer underwritten by a financial entity associated with the financial institution computing system, wherein clicking the graphic displays information on the predicted shortfall in funds
receiving, from the device, a second confirmation from the first account holder indicating acceptance of the loan offer; and
transferring funds from the second account of the at least one of the subset of second account holders to the first account of the first account holder responsive to receiving the second confirmation.

15. (canceled)

16. (canceled)

17. The non-transitory computer-readable media of claim 14, wherein the at least one second account holder comprises a plurality of second account holders of the subset of second account holders willing to provide a portion of the funds to finance the loan solution.

18. The non-transitory computer-readable media of claim 14, the operations further comprising transmitting an incentive to the at least one second account holder consequent to identifying the at least one second account holder willing to provide funds to finance at least the portion of the loan solution and consequent to receiving the first confirmation.

19. (canceled)

20. The non-transitory computer-readable media of claim 17, wherein the plurality of second account holders of the subset form a lending pool to finance the loan solution, each of the plurality of second account holders having a shared parameter.
